(19) United States
(12) Patent Application Publication
(10) Pub. No.: US 2021/0079205 A1
(43) Pub. Date: Mar. 18, 2021

(54) Bio-Degradable Composition

(71) Applicant: Sunta Chemical Corporation, Fangyuan Township (TW)

(72) Inventor: Wen-Hsi Yang, Fangyuan Township (TW)

(21) Appl. No.: 16/666,733

(22) Filed: Oct. 29, 2019

(30) Foreign Application Priority Data
Sep. 18, 2019 (TW) 108133554

(51) Int. Cl. C08L 27/06; C08J 11/10

(52) U.S. Cl. CPC C08L 27/06; C08J 11/105; C08J 2327/06; C08L 2205/06; C08L 2207/322; C08L 2201/06

(57) ABSTRACT

Present invention is related to a bio-degradable composition having: PVC powder 100 phr, a plasticizer 40˜60 phr and an enzyme 0.5˜4 phr. The bio-degradable material has degradation rate over 90% under anaerobic environment. The combination of plasticizer and enzyme give the present invention the ability of degrading. Because there is no additional bio material involved, the physical property and mechanical property of the present invention can be remained. Since the products made by the present invention only can be degraded under anaerobic environment, the products can maintain in good condition or qualities under normal circumstances with the existing of oxygen.

### FIELD OF INVENTION

The present invention generally relates to a composition, and more particularly it relates to a bio-degradable composition with high degradation rate and won't produce dioxin while burning.

The present invention has been developed primarily to be a film/membrane material for describing hereinafter with reference to this application. However, it will be appreciated that the invention is not limited to this particular field of use.

### BACKGROUND OF THE INVENTION

Polyvinyl Chloride (PVC) is one of the most commonly used versatile plastics in the world with nearly 60 million metric tons of manufacturing capacity per year. With PVC's excellent acid and alkali resistance, flame resistance and good processing ability, PVC has became widely used in many fields, like building materials, industrial products and daily consumer's goods.

However, as the rise of environmental protection awareness among society in recent years, it can't be denied that PVC still has its problems and limitations. Despite PVC has so many excellent abilities and various applications, this material is criticized of non-decomposable by the environment and exceeding production of carcinogenic pollutants such as dioxin when handling its waste. These are some problems for PVC being restricted from many applications.

In order to improve non-decomposable problem of PVC, some conventional techniques are developed by introducing some natural decomposable ingredients, such as starch or plant fiber powders to reduce the usage of PVC. The existence of natural decomposable ingredients somehow leads to pool physical and mechanical properties toward final product made by PVC. Hence, it is necessary to develop a bio-degradable composition that not only has bio-degradable ability, but also won't produce or only produce extremely low content of dioxin during burning. This bio-degradable composition can also maintain the physical and mechanical properties of PVC so as to meet the needs and demands of market and environmental protection at the same time.

It is eager to have a bio-degradable composition that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve shortcomings of conventional techniques for the conventional PVC composition that cannot be decomposed and will produce carcinogenic pollutants such as dioxin during burning, the present invention is required.

According to a first aspect of the present invention, a bio-degradable composition is provided with having: Polyvinyl Chloride powder 100 phr, a plasticizer 40˜60 phr and an enzyme 0.5˜4 phr. The bio-degradable material has degradation rate over 90% under anaerobic environment.

In accordance, the present invention has the following advantages:

1. The combination of plasticizer and enzyme give the present invention the ability of degrading. Because there is no additional bio material such as starch or fiber involved or adding in the bio-degradable composition, the physical and mechanical properties of the present invention can be maintained as conventional PVC products. Since the products made by the present invention only can be degraded under anaerobic environment, the products can remain in good condition or qualities under normal circumstances with the existing of oxygen. When the products made by the present invention becoming wastes, it can be simply recycled and degraded by creating anaerobic environment.

2. The test result shows that the present invention produces none or very low content of dioxin or furan after burning. This can benefit for those countries that do not recycle the said waste by degrading. The waste still can be burned without producing any carcinogenic pollutants such as dioxin or furan.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a gas accumulation measurement test of preferred embodiments in accordance with the present invention; and

FIG. 2 is a degradation test result of preferred embodiments in accordance with the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

A bio-degradable composition comprises: Polyvinyl Chloride (PVC) powder 100 phr, a plasticizer 40˜160 phr, and an enzyme 0.5˜4 phr.

The said plasticizer is preferable to be a plasticizer whose chemical structure without benzene ring structure or functional group, more preferable to be a plasticizer whose chemical structure is linear without benzene ring structure or functional group. One embodiment of the plasticizer may be soybean oil.

The enzyme (or catalyst) is preferred to be an ester. The said ester may include one or a combination of multiple types of ester. For example, the ester may be synthesized from inorganic acids (such as phosphoric acid or sulfuric acid) with alcohols. The ester can also be synthesized from lipid (or fat, oil with functional group of RCOOR″) with alcohol. The ester may also be synthesized from chlorinated derivatives of carboxylic acids.

The combination of the plasticizer and the enzyme provides the present invention with bio-degradable ability. The so-called bio-degradable ability refers to the final product made by the composition of the present invention can be degraded or decomposed totally (even the PVC part) or over 90% within a period of time at anaerobic environment.

The mechanism of why the present invention with high content of non-degradable PVC still can achieve high level of degradation ability is that the combination of the linear structure plasticizer with no benzene ring and the ester enzyme can trigger decomposition of enzyme and induce a large number of anaerobic bacteria in the environment to consume the degradable and non-degradable components of the present invention. Hence, the present invention will be gradually digested and decomposed into several gases to achieve the ability of degradation. The most important is that the degradation product of the present invention does not include carcinogenic pollutants such as dioxin.

The bio-degradable composition of the present invention may further include a filler no more than 20 phr and/or a stabilizer 1.5˜5 phr so as to achieve the purpose of cost down and good processability but still maintain the bio-degradable ability of the present invention. The filler may be one or a complex of calcium carbonate, calcium silicate, calcium sulfate, talc, titanium dioxide or antimonous oxide (Sb₂O₃). The existence of antimonous oxide at 3 phr or more further shows flame resistance ability.

With reference to below chart 1, a preferred embodiment of the present invention is provided.

CHART 1

| Sample No. | PVC powder | Plasticizer | | Enzyme |
|---|---|---|---|---|
| POSITIVE | 0 | 0 | | 0 |
| | (Natural bio-degradable | | | |
| | material 100 phr) | | | |
| NEGETIVE | 100 phr | 0 | | 0 |
| 1565 | 100 phr | 40 | phr | 1.5 phr |
| (Present invention) | | | | |
| 1566 | 100 phr | 40 | hr | 0 |
| (Control group) | | | | |

Sample No. 1565 in chart 1 is a preferred embodiment of the present invention with PVC powder 100 phr, the plasticizer 40 phr and the enzyme 1.5 phr. The plasticizer and the enzyme of this embodiment is soybean oil and the enzyme synthesized from inorganic acids with alcohols. Sample No. 1565 in chart 1 only represents a best or preferred embodiment of the present invention. This embodiment is not intended to limit the scope of the present invention. Other range of optional content of the present invention are also tested and proven valid.

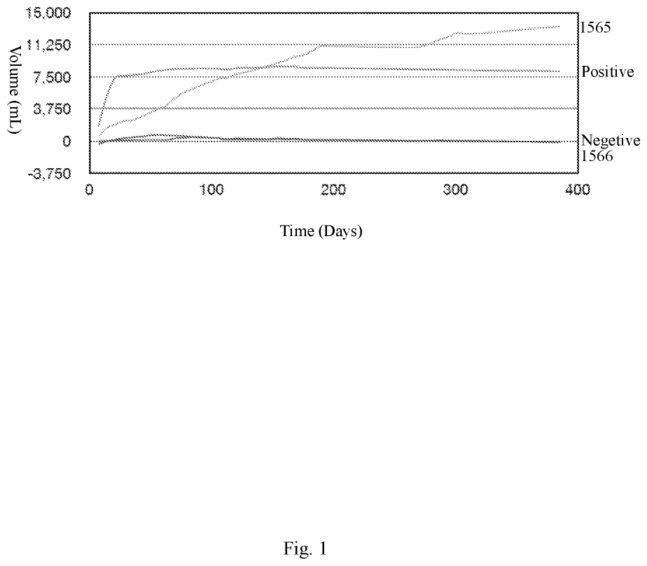

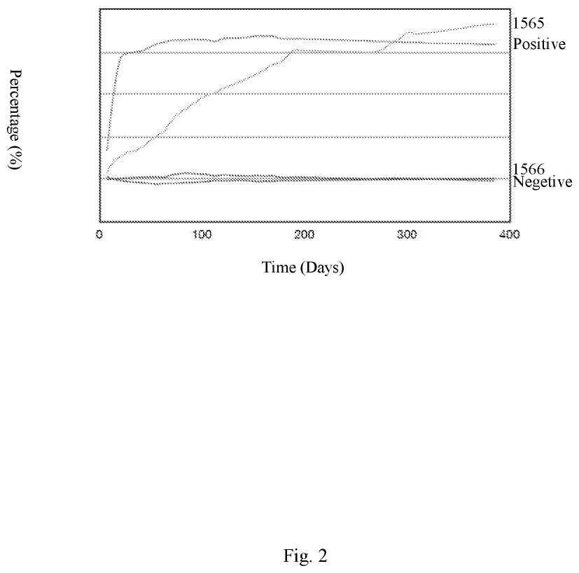

With reference to below chart 2, FIG. 1 and FIG. 2, a one year degradation/decomposition test is conducted. Test standard of this degradation/decomposition test is ASTM D5511-12 (Anaerobic bacteria bio-degradation test in oxygen free environment) by using samples in chart 1 with a form of thin film in thickness 1.15 mm and 686 g/m² unit weight. According to gas accumulation measurement in chart 2 and FIG. 1, the accumulated gas of each samples are measured during decomposition. The gas accumulated of sample No. 1565 of the present invention is significantly more than the gas accumulated of other samples. This means that the present invention has greater degradation ability among other samples. As shown by the samples named POSITIVE and No. 1565, these two samples can proof that the degradation rate of the present invention is faster than normal natural decomposable material. Samples named NEGATIVE and No. 1566 are shown no sign of degradation with almost no gas production during this test. Chart 2 and FIG. 2 show that during the one year degradation/decomposition, the sample No. 1565 do have degradation ability and the degradation rate can reach nearly 100%, even higher than the POSITIVE sample which is a natural decomposable material. Samples named NEGATIVE and No. 1566 are otherwise proven no degradation ability by this test.

CHART 2

| | NEGETIVE | POSITIVE | 1565 | 1566 |
|---|---|---|---|---|
| Volume of | 3175.9 | 11454.1 | 16650.6 | 3171.2 |
| Accumulated | | | | |
| Gas (mL) | | | | |
| Content of | 43.7 | 35.0 | 49.3 | 43.6 |
| Methane (CH₄ %) | | | | |
| Volume of | 1387.2 | 4014.6 | 8205.7 | 1381.4 |
| Methane (CH₄ mL) | | | | |
| Mass of | 0.99 | 2.87 | 5.86 | 0.99 |
| Methane (CH₄ g) | | | | |
| Content of | 36.5 | 42.8 | 42.8 | 42.5 |
| CO₂ (CO₂ %) | | | | |
| Volume of | 1159.8 | 4905.5 | 7120.8 | 1348.1 |
| CO₂ (CO₂ mL) | | | | |
| Mass of | 2.28 | 9.64 | 13.99 | 2.65 |
| CO₂ (CO₂ g) | | | | |
| Mass of | 1.43 | 1.36 | 4.78 | 8.21 |
| Degradation (g) | | | | |
| Degradation | −0.8 | 79.3 | 91.3 | 0.4 |
| Rate (%) | | | | |

Above samples are further tested for production of dioxin and furan by burning the film. Ashes or residues of the burning films of each samples are tested by standard “NIEA M801.13B”. The national standard for this test is that if the production of dioxin and furan are tested over 1.0 ng I-TEQ/g, the sample will be considered exceeding this standard. The test result of the present invention shows only 0.001 ng I-TEQ/g of dioxin and furan production which is lower than the national standard.

With reference to Chart 3, physical and mechanical properties of sample No. 1565 in accordance to the present invention are provided. Chart 3 shows that the present invention not only has high level of degradation ability but also has good physical and mechanical properties.

CHART 3

| Test Item | Test Standard | Values | | |
|---|---|---|---|---|
| Tensile | JIS-K-6772 | Warp | 22.38 | (kg/3 cm) |
| Strength | Tensile speed: | Woof | 18.35 | (kg/3 cm) |
| | 200 mm/min | | | |
| Elongation | JIS-K-6772 | Warp | 143 | (%) |
| | Tested when | Woof | 169 | (%) |
| | breakage | | | |
| Tearing | JIS-K-6772 | Warp | 2.53 | (kg) |
| Strength | | Woof | 2.36 | (kg) |
| Strip Off | JIS-K-6772 | Warp | 2.8 | (kg/3 cm) |
| Strength | | Woof | 1.89 | (kg/3 cm) |
| Flexulus | JIS-K-6545 | Warp | 10000 | (Times/5 Grade) |
| Resistance | (25° C.) | Woof | | |
| Bursting | Mullen Type | 10.5 (kg/cm²) | | |
| Strength | | | | |
| Blocking Test | JIS-K-6772 | 5 (Grade) | | |
| (at 70° C.) | | | | |
| Color Fastness | JIS-K-6772 | Dry | 5 | (Grade) |
| Test/Rubbing Test | | Wet | 5 | (Grade) |

With reference to below chart 4-5, these test results show that as the content of enzyme increased, the degradation condition of the present invention will become more obvious and faster. Each sample showed in chart 4 is produced into tested film and buried in soil for 9 months. The appearance of each sample after burying in soil shows in chart 5.

| | CHART 4 | | | | | | | | | | | | | | | |
|---|---|---|---|---|---|---|---|---|---|---|---|---|---|---|---|---|
| | Sample | | | | | | | | | | | | | | | |
| Content | 1 | | | | 2 | | | | 3 | | | | 4 | | | |
| PVC (phr) | 100 | | | | 100 | | | | 100 | | | | 100 | | | |
| Plasticizer (phr) | 95 | | | | 95 | | | | 95 | | | | 95 | | | |
| Enzyme (phr) | 0 | 0.5 | 1.5 | 3 | 0 | 0.5 | 1.5 | 3 | 0 | 0.5 | 1.5 | 3 | 0 | 0.5 | 1.5 | 3 |

| | | | | |
|---|---|---|---|---|
| Stabilizer (phr) | 2 | 2 | 2 | 2 |
| CaCO₃ (phr) | 20 | 20 | 20 | 20 |
| Sb₂O₃ (phr) | — | 0.5 | 1.5 | 3 |
| Flame resistance | None | None | None | Yes |
| ability | | | | |

| | CHART 5 | | | |
|---|---|---|---|---|
| | Enzyme content | | | |
| Sample | 0 phr | 0.5 phr | 1.5 phr | 3 phr |
| 1 | Complete and | Slightly | Cracking on | Severe |
| 2 | smooth, shows | cracking on the | the surface | cracking on the |
| 3 | no cracking on | surface | | surface |
| 4 | the surface | | | |

The bio-degradable composition of the present invention may be manufactured into a film, a membrane or various forms of applications for applying to building materials, industrial products or consumer's daily products. The bio-degradable composition of the present invention has great elastic property which is very suitable for producing artificial leather products. As described above, the present invention will only be degraded or decomposed in oxygen free environment with the existence of anaerobic bacteria, the quality and appearance of the final products made by the present invention will be perfectly preserved under normal environment.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A bio-degradable composition comprising:
Polyvinyl Chloride powder 100 phr,
a plasticizer 40˜160 phr, and
an enzyme 0.5˜4 phr, wherein:
the bio-degradable composition has degradation rate over 90% at anaerobic environment.

2. The bio-degradable composition as claimed in claim 1, wherein a filler below 20 phr and/or a stabilizer 1.5˜5 phr is further included in the bio-degradable composition.

3. The bio-degradable composition as claimed in claim 2, wherein the filler includes one or a complex of calcium carbonate, calcium silicate, calcium sulfate, talc, titanium dioxide or antimonous oxide (Sb₂O₃).

4. The bio-degradable composition as claimed in claim 1, wherein a chemical structure of the plasticizer is linear without benzene ring structure.

5. The bio-degradable composition as claimed in claim 2, wherein a chemical structure of the plasticizer is linear without benzene ring structure.

6. The bio-degradable composition as claimed in claim 3, wherein a chemical structure of the plasticizer is linear without benzene ring structure.

7. The bio-degradable composition as claimed in claim 1, wherein the plasticizer is soybean oil.

8. The bio-degradable composition as claimed in claim 2, wherein the plasticizer is soybean oil.

9. The bio-degradable composition as claimed in claim 3, wherein the plasticizer is soybean oil.

10. The bio-degradable composition as claimed in claim 1, wherein the enzyme is an ester.

11. The bio-degradable composition as claimed in claim 2, wherein the enzyme is an ester.

12. The bio-degradable composition as claimed in claim 3, wherein the enzyme is an ester.

13. The bio-degradable composition as claimed in claim 10, wherein the ester is synthesized from inorganic acids with alcohols, lipid with alcohol or chlorinated derivatives of carboxylic acids.

14. The bio-degradable composition as claimed in claim 11, wherein the ester is synthesized from inorganic acids with alcohols, lipid with alcohol or chlorinated derivatives of carboxylic acids.

15. The bio-degradable composition as claimed in claim 12, wherein the ester is synthesized from inorganic acids with alcohols, lipid with alcohol or chlorinated derivatives of carboxylic acids.

16. The bio-degradable composition as claimed in claim 13, wherein the inorganic acids include phosphoric acid or sulfuric acid.

17. The bio-degradable composition as claimed in claim 14, wherein the inorganic acids include phosphoric acid or sulfuric acid.

18. The bio-degradable composition as claimed in claim 15, wherein the inorganic acids include phosphoric acid or sulfuric acid.
